(19) United States
(12) Patent Application Publication
(10) Pub. No.: US 2026/0346351 A1
(43) Pub. Date: Nov. 5, 2026

(54) FILING TOOL FOR A SAW CHAIN

(71) Applicant: HUSQVARNA AB, Huskvarna (SE)

(72) Inventors: Mattias ROTSTEDT, Huskvarna (SE); Mattias KARLSSON, Huskvarna (SE)

(21) Appl. No.: 19/486,459

(22) PCT Filed: May 20, 2024
(86) PCT No.: PCT/SE2024/050484

§ 371 Date: Nov. 21, 2025

(30) Foreign Application Priority Data
May 25, 2023 (SE) 2350639-7

(51) Int. Cl. B23D 63/16

(52) U.S. Cl. CPC B23D 63/162

(57) ABSTRACT

A filing tool 200 for sharpening a chain 100 of a chainsaw includes a first handle assembly 210 disposed at a first end of the filing tool 200, a second handle assembly 220 disposed a fixed distance away from the first handle assembly 210 at a second end of the filing tool 200, a first guide rail 230 operably coupling the first handle assembly 210 to the second handle assembly 220, a second guide rail 240 operably coupling the first handle assembly 210 to the second handle assembly 220, a depth gauge file 250 disposed between the first guide rail 230 and the second guide rail 240, a first cutter file 260 disposed between the first guide rail 230 and the depth gauge file 250, and a second cutter file 270 disposed between the second guide rail 240 and the depth gauge file 250. The filing tool 200 may sharpen cutter links 180 in first and second orientations without moving either of the first or second cutter files (260, 270) relative to the filing tool 200.

### TECHNICAL FIELD

Example embodiments generally relate to handheld power equipment and, more particularly, relate to equipment for sharpening a chainsaw chain.

### BACKGROUND

Chainsaws are commonly used in both commercial and private settings to cut timber or perform other rigorous cutting operations. Because chainsaws are typically employed in outdoor environments, and the work they are employed to perform often inherently has high demands of the chainsaw, it is important that the chain is kept in ideal working condition to allow for the most efficient operation of the chainsaw. The chain includes cutting teeth that engage lumber or another medium in order to cut the medium as the teeth are passed over a surface of the medium at high speed.

Given that the chainsaw may be employed to cut media of various sizes and types, it should be appreciated that the chain itself may have an impact on the effectiveness of the cutting operations. In particular, cutter edges of the chain may wear over time. This wear occurs based on the edges being grinded or abraded by the material that the chain is cutting. As the chain is worn, it is undesirable for the efficiency of the chain to be excessively impacted by the wearing process. Thus, an operator of the chainsaw will often take the time to file the chain in order to keep the chainsaw cutting smoothly.

As such, it may be desirable to have a tool that makes the process of filing the chain on a chainsaw less time intensive, less labor intensive, and more intuitive for an operator.

### BRIEF SUMMARY OF SOME EXAMPLES

Some example embodiments may provide for a filing tool for sharpening a chain of a chainsaw. The filing tool may include a first handle assembly disposed at a first end of the filing tool, a second handle assembly disposed a fixed distance away from the first handle assembly at a second end of the filing tool, a first guide rail operably coupling the first handle assembly to the second handle assembly, a second guide rail operably coupling the first handle assembly to the second handle assembly, the second guide rail being substantially parallel to the first guide rail, a depth gauge file disposed between the first guide rail and the second guide rail, a first cutter file disposed between the first guide rail and the depth gauge file, and a second cutter file disposed between the second guide rail and the depth gauge file. The filing tool may sharpen first cutter links of the chain in a first orientation and second cutter links of the chain in a second orientation without moving either of the first or second cutter files relative to the filing tool.

Some example embodiments may provide for a filing tool for sharpening a chain for a chainsaw. The filing tool may include a first handle assembly that may be disposed at a first end of the filing tool, a second handle assembly that may be disposed a fixed distance away from the first handle assembly at a second end of the filing tool, a first guide rail that may operably couple the first handle assembly to the second handle assembly, a second guide rail that may operably couple the first handle assembly to the second handle assembly, the second guide rail being substantially parallel to the first guide rail, a depth gauge file that may be disposed between the first guide rail and the second guide rail, a first cutter file that may be disposed between the first guide rail and the depth gauge file, and a second cutter file that may be disposed between the second guide rail and the depth gauge file. The depth gauge file may be disposed in a first plane that may contain the first guide rail and the second guide rail. The first cutter file and the second cutter file may be coplanar in a second plane that may be disposed on a same side of the first plane.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a chainsaw chain according to an example embodiment;

FIG. 2 represents a block diagram schematic plan view of a filing tool according to an example embodiment;

FIG. 3 depicts a cross section view taken along line 3-3 of the filing tool in FIG. 2 according to an example embodiment;

FIG. 4 depicts a three dimensional top view of a filing tool according to an example embodiment;

FIG. 5 depicts a three dimensional top view of a filing tool according to an example embodiment; and

FIG. 6 depicts a section view of the filing tool of FIG. 2 according to an example embodiment.

FIG. 7 illustrates a locking mechanism in a handle assembly.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

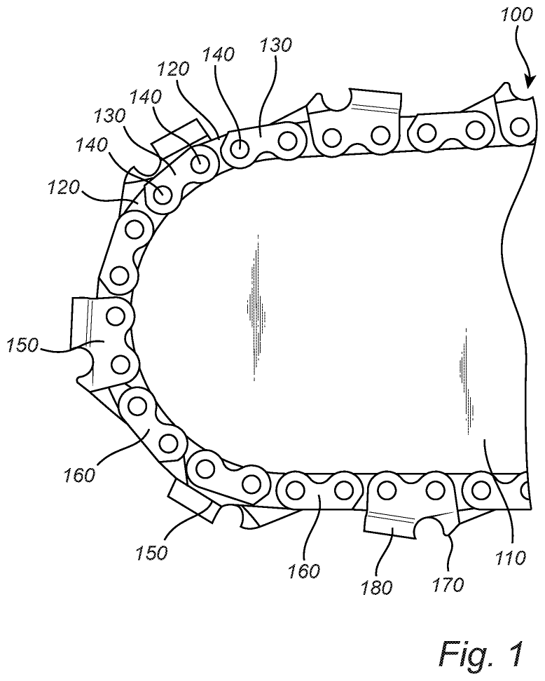

FIG. 1 illustrates a typical chainsaw chain 100 disposed on a guide bar 110. The chain 100 includes a plurality of center drive links 120 that each include a portion thereof that rides in a channel of the guide bar 110. Each center drive link 120 is attached to an adjacent pair of side links 130 by rivets 140 that extend perpendicular to the longitudinal length of the links. A rivet 140 is provided at the front portion of each center drive link 120 to attach the center drive link 120 to the rear portion of a preceding side links 130 and another rivet 140 is provided at the rear portion of each center drive link 120 to attach the center drive link 120 to the front portion of a subsequent side links 130. As such, each pair of side links 130 connects to opposing sides of the center drive links 120, and the connections are repeated in alternating fashion to complete a circular or endless chain.

For some pairs of side links 130 of the chain 100 one of the side links 130 may be formed as a cutter link 150. Meanwhile, pairs of side links that do not include a cutter link 150 may be referred to as tie links 160. The cutter links 150 may be provided with two portions including a depth gauge portion 170 and a cutting portion 180. The cutting portion 180 may generally engage material that extends beyond the depth of the depth gauge portion 170 when the chain 100 is rotated. In some embodiments, cutting portions 180 may be alternatingly oriented in different manners. In this regard, there may be at least one left hand cutting portion 180 and at least one right hand cutting portion 180. In some cases, the cutting portions 180 may alternate between left and right hand orientations all the way around the chain 100 such that no two consecutive cutting portions 180 are the same orientation. Meanwhile, the tie links 160 may not include cutting portions 180 or depth gauge portions 170 and may be provided to simply extend the length of the chain 100 while providing a space between portions of the chain 100 that will create friction during cutting operations. If every side link 130 was a cutter link 150, the friction on the chain 100 would be very high, and it would be difficult to provide sufficient power to turn the chain, and control of the chainsaw could also become difficult. Additionally, if the cutter links 150 were merely allowed to engage large portions of the media to be cut without a restriction on the cutting depth for each cycle, the friction would be high and the run of the chain 100 would be less smooth. Accordingly, the depth gauge portion 170 allows a limit to be placed on the cutting depth or amount of material to be cut with each pass of the cutter link 150.

As mentioned above, the cutting portion 180 may engage with any material that extends beyond the depth of the depth gauge portion 170 as the chain 100 moves around the guide bar 110 when the chainsaw is in use. Therefore, the depth gauge portion 170 and the cutting portion 180 may be the portions of the chain 100 that are subject to wear down the fastest with the continued normal operation of the chainsaw. As such, filing the cutting portions 180 and the depth gauge portions 170 may be an essential part of chain 100 maintenance for any chainsaw operator. Accordingly, a tool for filing the chain 100 should be efficient and intuitive to operate.

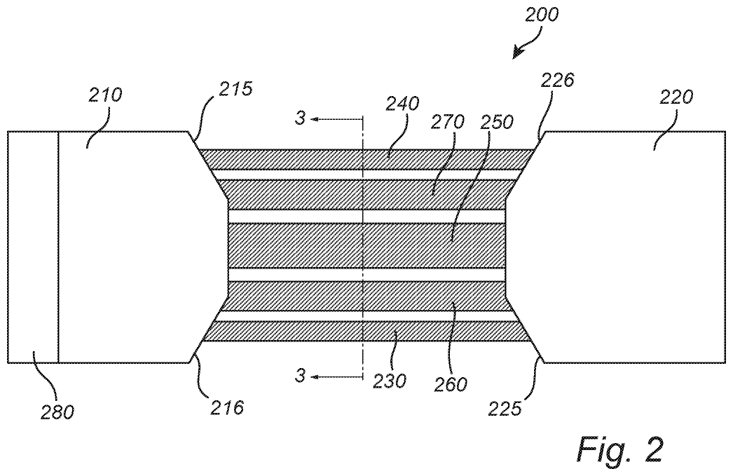

FIG. 2 represents a block diagram schematic plan view of a filing tool 200 according to an example embodiment. The filing tool 200 may include a first handle assembly 210, a second handle assembly 220, a first guide rail 230, a second guide rail 240. A depth gauge file 250, a first cutter file 260 and a second cutter file 270 may as illustrated be attached thereto. The first handle assembly 210 may be operably coupled to the second handle assembly 220 via the first guide rail 230 and the second guide rail 240. In some embodiments, the first guide rail 230 and the second guide rail 240 may be fixed in place with respect to the first handle assembly 210 and the second handle assembly 220. In some cases, the first guide rail 230 and the second guide rail 240 may have rectangular cross sections. The first and second guide rails 230, 240 may be spaced apart from each other such that the first guide rail 230 and the second guide rail 240 each rest on an outermost face of consecutive cutting portions 180 of the chain 100 when the filing tool 200 is in use. In some other embodiments, the distance between consecutive cutting portions 180 may vary. In this regard, the distance between every other rivet 140 divided by two is referred to as the pitch of a chain 100. The filing tool 200 may be constructed to match the dimensions of any standardized pitch. For example, for a chain 100 with a pitch of approximately ⅜″, the filing tool 200 file diameter may be approximately 5.5 mm. A single filing tool 200 may be associated with one pitch, which may be determined by the distance between the first guide rail 230 and the second guide rail 240. The first guide rail 230 and the second guide rail 240 may not perform any filing action on the cutting portions 180 when the filing tool 200 is in use, but instead ride over a top surface of the cutting portions 180 to position the first cutter file 260 or the second cutter file 270 properly for filing at a leading edge (or cutting edge) of the cutting portion 180 that is between the first and second guide rails 230 and 240.

In some embodiments, the first handle assembly 210 may include a first angled face 215 and a second angled face 216 and the second handle assembly 220 may include a third angled face 225 and a fourth angled face 226. The first, second, third and fourth angled faces 215, 216, 225, 226 may be shaped such that the first and second guide rails 230, 240 are not perpendicular with the first, second, third and fourth angled faces 215, 216, 225, 226. In some embodiments, the first and second angled faces 215, 216 may be chamfered corners of the first handle assembly 210 proximate to the first and second guide rails 230, 240, while the third and fourth angled faces 225, 226 may be chamfered corners of the second handle assembly 220 proximate to the first and second guide rails 230, 240. In other words, the first and second guide rails 230, 240 may operably couple to the first and second handle assemblies 210, 220 at the first, second, third and fourth angled faces 215, 216, 225, 226. In some cases, the first, second, third and fourth angled faces 215, 216, 225, 226 may form a smallest angle of about 30° with the first and second guide rails 230, 240, respectively. While an angle of about 25° to about 30° may be most common, in some cases, the angle may range from about 10° to about 35°. In an example embodiment, the first angled face 215 and the third angled face 225 may each be disposed substantially parallel to the guide bar 110 of the chainsaw when the filing tool 200 is configured to file the left hand oriented cutting portions 180 of the chain 100. On the contrary, the second angled face 216 and the fourth angled face 226 may be disposed substantially parallel to a guide bar 110 of the chainsaw when the filing tool 200 is configured to file the right hand oriented cutting portions 180 of the chain 100. In other words, the first, second, third and fourth angled faces 215, 216, 225, 226 may help indicate the proper orientation of the filing tool 200 when filing the chain 100 in both the left and right hand orientations.

The depth gauge file 250 may be disposed in between the first cutter file 260 and the second cutter file 270. In some embodiments, the depth gauge file 250 may include at least one filing surface configured to contact a depth gauge portion 170 of the chain 100 when the filing tool 200 is in use. In some cases, the depth gauge file 250 may have a rectangular cross section and the filing surface may be planar, and in some other embodiments the depth gauge file 250 may have a trapezoidal cross section, or other shapes. In an example embodiment, the depth gauge file 250 may have an arcuate filing surface. Additionally, the depth gauge file 250 may be fixed in place in the first handle assembly 210 at one end and the second handle assembly 220 at the other end. In some other embodiments, the depth gauge file 250 may also be movable within the first and second handle assemblies 210 and 220. In this regard, the depth gauge file 250 may be adjusted to a preferred orientation setting based on the filing needs of the particular chain 100 and to file a depth gauge portion 170 of the chain 100 to a different level. The depth gauge file 250 may also be removable in order to facilitate replacing the file 250 in the event that it is old or worn out.

The first cutter file 260 may be disposed between the depth gauge file 250 and the first guide rail 230, and the second cutter file 270 may be disposed between the depth gauge file 250 and the second guide rail 240. In this regard, the first cutter file 260 or the second cutter file 270 may be configured to contact an edge (i.e., the leading or cutting edge) of the cutting portion 180 when the filing tool 200 is in use depending on the orientation of the filing tool 200 and the desired filing direction of the cutting portion 180. In some embodiments, the first and second cutter files 260, 270 may comprise a rounded cross section. This may allow for the first cutter file 260 or the second cutter file 270 to assume an ideal filing position relative to the cutting portion 180 of the chain 100 where the cutting portion 180 of the chain 100 may be visible to the user of the filing tool 200. The visibility of the cutting portion 180 of the chain 100 may be important so that the user of the filing tool 200 may more accurately gauge the progress of the filing and may know when to stop filing, accordingly. Thus, the first cutter file 260 or the second cutter file 270 may be positioned deeper in the chain 100 than the depth gauge file 250 so as to be below the outermost face of the cutting portion 180 and between the cutting portion 180 and the depth gauge portion 170. In other words, the first and second cutter files 260, 270 may be coplanar and disposed on a same side of a first plane 290 containing the first guide rail 230 and the second guide rail 240 or being defined by the centre axis of the guide rails 230, 240. In an example embodiment, the depth gauge file 250 may be disposed parallel to the first plane 290. In other words, in some embodiments the depth gauge file 250 may be disposed in the first plane 290, whereas in other embodiments the depth gauge file 250 may be disposed between the first plane 290 and a second plane 300 containing the first and second cutter files 260, 270. In some cases, the first and second cutter files 260, 270 may have a hexagonal or goofy shaped cross section as well. In such cases, the shape of the cross section of the first and second cutter files 260, 270 may vary based on the cut of the chain 100 being filed or the desired results of the filing.

In some embodiments the first handle assembly 210, the second handle assembly 220, or both, may comprise an opening assembly 280. The opening assembly 280 may include a door disposed on the first handle assembly 210 or the second handle assembly 220 that an operator may open in order to access the depth gauge file 250 and the first and second cutter files 260, 270. In this regard, the opening assembly 280 may allow access to the files 250, 260, 270 in the event that the depth gauge file 250 or the first cutter file 260 or the second cutter file 270 must be repaired or replaced. In some embodiments, the opening assembly 280 may be embodied as a door with a hinge. In this regard, the depth gauge file 250 and the first and second cutter files 260, 270 may be removable from the filing tool 200 via a plurality of actions. In some embodiments, the depth gauge file 250 and the first and second cutter files 260, 270 may be removed via a sliding motion in which the files 250, 260, 270 come out of the first handle assembly 210 by sliding in a direction substantially parallel to the first and second guide rails 230 and 240. In other cases, where the opening assembly 280 permits appropriate access, the files 250, 260, 270 may be removable via a lifting motion in which the files 250, 260, 270 lift out of the first handle assembly 210 in a direction coming out of the page as depicted in FIG. 2. The opening assembly 280 may be configured as a removable cap that may separate from the respective handle assembly 210, 220 in a direction substantially parallel to the first guide rail 230 and the second guide rail 240 and away from the other respective handle assembly 210, 220 in order to provide access to the depth gauge file 250 and the first and second cutter files 260, 270. In some other embodiments, the opening assembly 280 may include other structures of the like that may be configured to permit removal of the depth gauge file 250 and the first and second cutter files 260, 270.

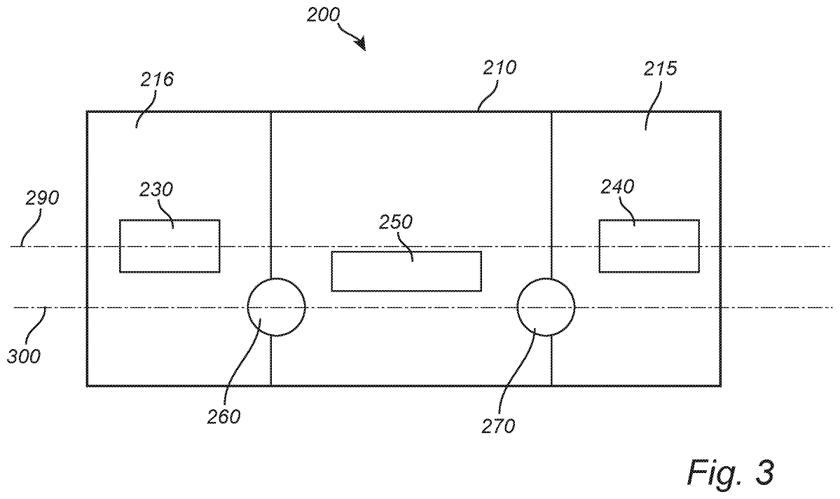

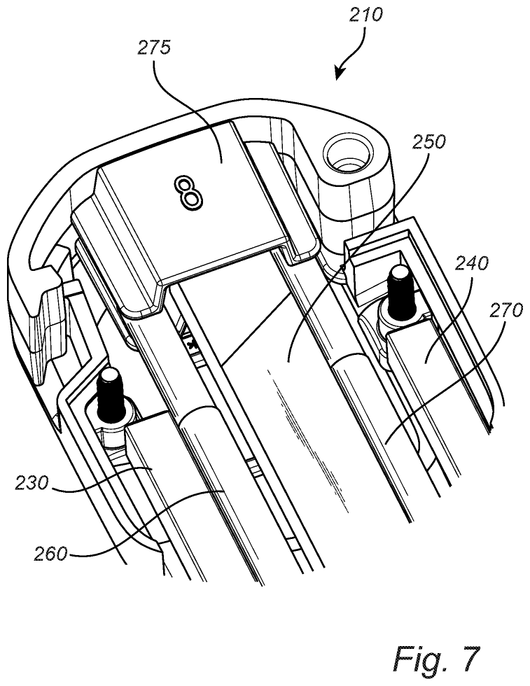

FIG. 7 illustrates one example of the first handle assembly 210, where a lid has been removed, exposing a holder 275 configured to hold an end of a depth gauge file 250 as well as the ends of a first 260 and a second 270 cutting tooth file. A similar holder may be used in the second handle assembly 220, and the holders co-operate to hold the gauge file 250 and the first and second cutter files 260, 270 in the desired orientation and plane with regard to the plane 290 (cf. FIG. 3) of the guide rails 230, 240. The holder 275 may be configured to clasp the files 250, 260, 270 firmly when the lid of the handle assembly is attached thereto. While in the present case a holder 275 common to the files 250, 260, 270 is shown, individual holders are also conceivable. It is possible, especially if one end of the cutting tooth files 260, 270 is polygonal or flat to prevent the file from turning in the holder once clasped, such that the user can choose to make a specific circular section, for instance, of the file face the cutting tooth, for instance to wear the file surface uniformly over its periphery.

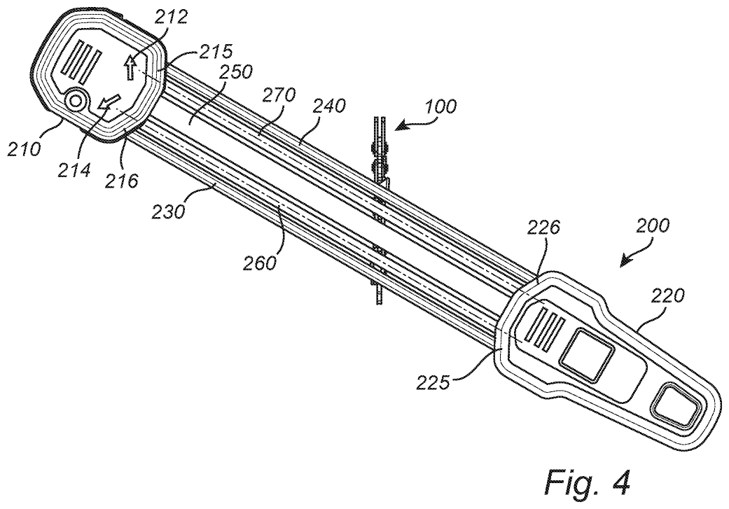

FIG. 3 depicts a cross section taken along line 3-3 in FIG. 2 of the filing tool 200 according to an example embodiment. FIG. 3 shows the first guide rail 230, the first cutter file 260, the depth gauge file 250, the second cutter file 270 and the second guide rail 240 as described above. As previously mentioned, the first and second cutter files 260, 270 may be disposed on a same side of the first plane 290 containing the first guide rail 230 and the second guide rail 240 and coplanar within the second plane 300. In this regard, the filing tool 200 may be used to file both left and right hand cutting portions 180 via the first and second cutter files 260, 270 without modifying the filing tool 200 at all between filing the left and right hand cutting portions 180. As such, the filing tool 200 may not have any moving parts, aside from the opening assembly 280 which may allow for the removal of the files 250, 260, 270 for repair or replacement. Since the first and second cutter files 260, 270 may be disposed coplanar in the second plane 300 on the same side of the first plane 290, the user may be afforded multiple advantages over other designs. For instance, the user may have improved visibility of the cutting portion 180 while it is being filed. In this regard, some other designs may have the second cutter file 270 disposed on an opposite side of the second plane 300 from the first cutter file 260. In such cases, the second cutter file 270 may block the user's view of the first cutter file 260 while the first cutter file 260 may be filing the chain 100. As such, the present invention may allow the user to be more efficient when filing the chain 100 by being able to see whether or not the file is working easier and when to stop filing accordingly. Additionally, the switch from filing the left handed cutting portions 180 to the right handed cutting portions 180 may be easier and require less effort than other designs that may have the second cutter file 270 disposed on an opposite side of the second plane 300 from the first cutter file 260. More details on the operation of the filing tool 200 will be described below in reference to FIGS. 4-6.

FIG. 4 depicts a three dimensional top view of the filing tool 200 according to an example embodiment. The filing tool 200 shown in FIG. 4 may be displayed in an orientation suitable for filing left hand cutting portions 180. FIG. 4 helps depict the visibility of the chain 100 through the spaces between each of the first guide rail 230, the second guide rail 240, the depth gauge file 250 and the first and second cutter files 260, 270. Seeing the chain through these components may enhance the speed and precision of the operator using the filing tool 200. FIG. 4 may also show the proper alignment of the angle on the first handle assembly 210 and the second handle assembly 220 with the chainsaw guide bar 110. In this regard, the first and second angled faces 215, 216 may be disposed at corners of the first handle assembly 210 and the third and fourth angled faces 225, 226 may be disposed at corners of the second handle assembly 220, proximate to where the first and second guide rails 230, 240 operably couple to the first and second handle assemblies 210, 220. The angle formed by the first, second, third and fourth angled faces 215, 216, 225, 226 with the first and second guide rails 230, 240 may indicate which direction the filing tool 200 may be filing in. For example, as shown in FIG. 4, the first angled face 215 and the third angled face 225 may both be substantially parallel to the direction of extension of the guide bar 110 responsive to the filing tool 200 being in the proper orientation suitable for filing left hand cutting portions 180. The user may be able to verify that the position of the filing tool 200 is correct by aligning the first orientation indicator 212, disposed proximate to the first angled face 215, with the direction of extension of the guide bar 110, as shown in FIG. 4. In the orientation shown in FIG. 4, the first cutter file 260 may be actively filing the cutting portion 180, while the second cutter file 270 may not be in contact with any cutting portion 180.

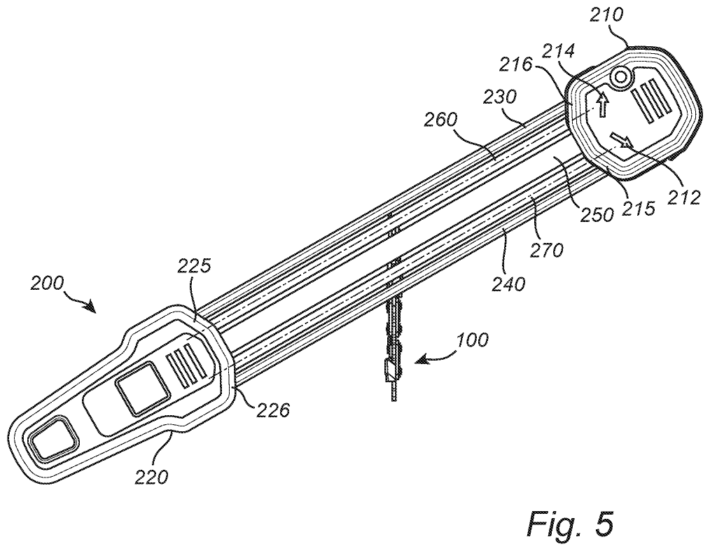

FIG. 5 depicts a three dimensional top view of the filing tool 200 according to an example embodiment. The filing tool 200 shown in FIG. 5 may be displayed in an orientation suitable for filing right hand cutting portions 180. FIG. 5 helps depict the visibility of the chain 100 through the spaces between each of the first guide rail 230, the second guide rail 240, the depth gauge file 250 and the first and second cutter files 260, 270. Seeing the chain through these components may enhance the speed and precision of the operator using the filing tool 200. FIG. 5 may also show the proper alignment of the angle on the first handle assembly 210 and the second handle assembly 220 with the chainsaw guide bar 110. In this regard, the first and second angled faces 215, 216 may be disposed at corners of the first handle assembly 210 and the third and fourth angled faces 225, 226 may be disposed at corners of the second handle assembly 220, proximate to where the first and second guide rails 230, 240 operably couple to the first and second handle assemblies 210, 220. The angle formed by the first, second, third and fourth angled faces 215, 216, 225, 226 with the first and second guide rails 230, 240 may indicate which direction the filing tool 200 may be filing in. For example, as shown in FIG. 5, the second angled face 216 and the fourth angled face 226 may both be substantially parallel to the direction of extension of the guide bar 110 responsive to the filing tool 200 being in the proper orientation suitable for filing right hand cutting portions 180. The user may be able to verify that the position of the filing tool 200 is correct by aligning the second orientation indicator 214, disposed proximate to the second angled face 216, with the direction of extension of the guide bar 110, as shown in FIG. 5. In the orientation shown in FIG. 5, the second cutter file 270 may be actively filing the cutting portion 180, while the first cutter file 260 may not be in contact with any cutting portion 180.

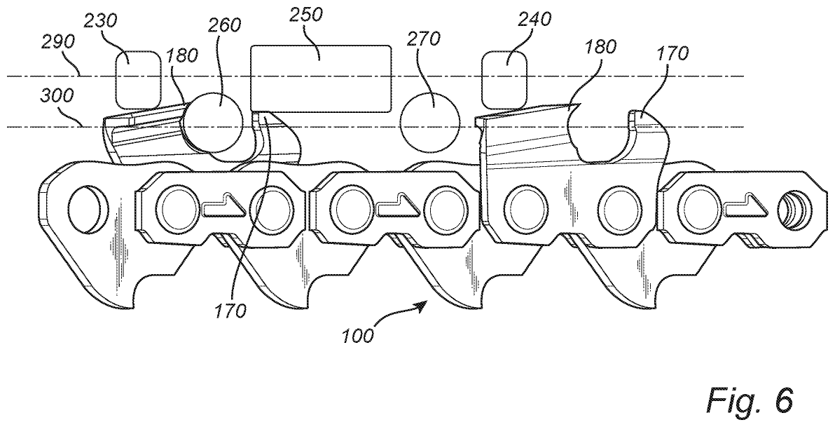

In order to alternate between the respective orientations depicted in FIGS. 5 and 6, the user may simply rotate the filing tool 200 approximately 120° within the same plane until the first or second orientation indicator 212, 214 may be aligned to be substantially parallel with the guide bar 110. In other words, the filing tool 200 may not have to be flipped upside down, nor may any file 250, 260, 270 need to be moved within the filing tool 200 in order to transition from filing left hand cutting portions 180 to filing right hand cutting portions 180. Responsive to the proper alignment of the filing tool 200 in either the left or right hand orientation, the user may commence filing by moving the filing tool 200 back and forth in a straight line extending substantially parallel to the direction of extension of the files 250, 260, 270, with the first handle assembly 210 being disposed further away from the user than the second handle assembly 220 in both orientations.

FIG. 6 depicts a section view of the filing tool 200 according to an example embodiment. In the embodiment shown in FIG. 6, the first cutter file 260 and the second cutter file 270 may be disposed coplanar with each other in the second plane 300 on a same side of the first plane 290. The first and second cutter files 260, 270 may be fixed in place below the first plane 290. The first plane 290 may contain the first guide rail 230, the second guide rail 240, and the depth gauge file 250. FIG. 6 also shows a clearer look at the alignment of the first guide rail 230, second guide rail 240 and depth gauge file 250 with respect to the chain 100. In some cases, the depth gauge file 250 may be fixed in the first plane 290. However, in other cases, the depth gauge file 250 may have an option of being moved out of the first plane 290 so that a different depth for the depth gauge on the chain 100 may be set. Similar to FIG. 4, FIG. 6 depicts the first cutter file 260 actively filing the cutting portion 180 while the second cutter file 270 may not be in contact with any cutting portion 180 of the chain 100.

Some example embodiments may provide for a filing tool for sharpening a chain of a chainsaw. The filing tool may include a first handle assembly disposed at a first end of the filing tool, a second handle assembly disposed a fixed distance away from the first handle assembly at a second end of the filing tool, a first guide rail operably coupling the first handle assembly to the second handle assembly, a second guide rail operably coupling the first handle assembly to the second handle assembly, the second guide rail being substantially parallel to the first guide rail, a depth gauge file disposed between the first guide rail and the second guide rail, a first cutter file disposed between the first guide rail and the depth gauge file, and a second cutter file disposed between the second guide rail and the depth gauge file. The filing tool may sharpen first cutter links of the chain in a first orientation and second cutter links of the chain in a second orientation without moving either of the first or second cutter files relative to the filing tool.

The filing tool of some embodiments may include additional features, modifications, augmentations and/or the like to achieve further objectives or enhance the performance of the filing tool. The additional features, modifications, augmentations and/or the like may be added in any combination with each other. Below is a list of various additional features, modifications, and augmentations that can each be added individually or in any combination with each other. For example, the depth gauge file may be disposed in a first plane containing the first guide rail and the second guide rail. In an example embodiment, the first cutter file and the second cutter file may be coplanar in a second plane which may be disposed on a same side of the first plane. In some cases, the depth gauge file may be movable out of the first plane to file a depth gauge of the chain to a different level. In an example embodiment, the first handle assembly may include a first angled face and a second angled face which may be disposed at respective corners of the first handle assembly. In some cases, the second handle assembly may include a third angled face and a fourth angled face disposed at respective corners of the second handle assembly. In an example embodiment, the first angled face may be substantially parallel with the third angled face and the second angled face may be substantially parallel with the fourth angled face. In some cases, the first angled face 215 and the third angled face 225 may both be substantially parallel to a direction of extension of the chain 100 responsive to the filing tool 200 being aligned for filing the first cutter links of the chain 100 in the first orientation. In an example embodiment, the first handle assembly may further include a first alignment indicator configured to confirm, with the operator, proper alignment of the filing tool 200 relative to the chain 100 responsive to the filing tool 200 being aligned for filing the first cutter links of the chain 100 in the first orientation. In some cases, the second angled face 216 and the fourth angled face 226 may both be substantially parallel to a direction of extension of the chain 100 responsive to the filing tool 200 being aligned for filing the second cutter links of the chain 100 in the second orientation. In an example embodiment, the first handle assembly may further include a second alignment indicator configured to confirm, with the operator, proper alignment of the filing tool 200 relative to the chain 100 responsive to the filing tool 200 being aligned for filing the second cutter links of the chain 100 in the second orientation. In an example embodiment, a cross section of the cutter file may be circular. In some cases, a cross section of the cutter file may be hexagonal or goofy shaped. In an example embodiment, the depth gauge file may have a planar filing surface. In some cases, the depth gauge file may have a trapezoidal cross section. In an example embodiment, at least one of the first and second handle assemblies may include an opening assembly configured to allow the depth gauge file, the first cutter file, and the second cutter file to slide in a direction substantially parallel to the first and second guide rails in order to allow for the replacement of the first or second cutter files or the depth gauge file. In some cases, at least one of the first and second handle assemblies may include an opening assembly configured to allow the depth gauge file, the first cutter file, and the second cutter file to lift in a direction normal to the first and second guide rails in order to allow for the replacement of the first or second cutter files or the depth gauge file.

Some example embodiments may provide for a filing tool for sharpening a chain for a chainsaw. The filing tool may include a first handle assembly that may be disposed at a first end of the filing tool, a second handle assembly that may be disposed a fixed distance away from the first handle assembly at a second end of the filing tool, a first guide rail that may operably couple the first handle assembly to the second handle assembly, a second guide rail that may operably couple the first handle assembly to the second handle assembly, the second guide rail being substantially parallel to the first guide rail, a depth gauge file that may be disposed between the first guide rail and the second guide rail, a first cutter file that may be disposed between the first guide rail and the depth gauge file, and a second cutter file that may be disposed between the second guide rail and the depth gauge file. The depth gauge file may be disposed in a first plane that may contain the first guide rail and the second guide rail. The first cutter file and the second cutter file may be coplanar in a second plane that may be disposed on a same side of the first plane.

The filing tool of some embodiments may include additional features, modifications, augmentations and/or the like to achieve further objectives or enhance the performance of the filing tool. The additional features, modifications, augmentations and/or the like may be added in any combination with each other. Below is a list of various additional features, modifications, and augmentations that can each be added individually or in any combination with each other. For example, the depth gauge file may be movable out of the first plane to file a depth gauge of the chain to a different level. In some cases, the first handle assembly may include a first angled face and a second angled face disposed at respective corners of the first handle assembly. In an example embodiment, the second handle assembly may include a third angled face and a fourth angled face disposed at respective corners of the second handle assembly. In some cases, the first angled face may be substantially parallel with the third angled face and the second angled face may be substantially parallel with the fourth angled face.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

Some examples of the present disclosure include:
1. A filing tool 200 for sharpening a chain 100 for a chainsaw, the filing tool 200 comprising:
a first handle assembly 210 disposed at a first end of the filing tool 200;
a second handle assembly 220 disposed a fixed distance away from the first handle assembly 210 at a second end of the filing tool 200;
a first guide rail 230 operably coupling the first handle assembly 210 to the second handle assembly 220;
a second guide rail 240 operably coupling the first handle assembly 210 to the second handle assembly 220, the second guide rail 240 being substantially parallel to the first guide rail 230;
a depth gauge file 250 disposed between the first guide rail 230 and the second guide rail 240;
a first cutter file 260 disposed between the first guide rail 230 and the depth gauge file 250; and
a second cutter file 270 disposed between the second guide rail 240 and the depth gauge file 250,
wherein the filing tool 200 sharpens first cutter links 180 of the chain 100 in a first orientation and second cutter links 180 of the chain 100 in a second orientation without moving either of the first or second cutter files 260, 270 relative to the filing tool 200.
2. The filing tool of example 1, wherein the depth gauge file 250 is disposed parallel to a first plane 290 containing the first guide rail 230 and the second guide rail 240.
3. The filing tool of example 2, wherein the first cutter file 260 and the second cutter file 270 are coplanar in a second plane 300 disposed on a same side of the first plane 290.
4. The filing tool of example 2, wherein the depth gauge file 250 is movable out of the first plane 290 to file a depth gauge 170 of the chain 100 to a different level.
5. The filing tool of example 1, wherein the first handle assembly 210 comprises a first angled face 215 and a second angled face 216 disposed at respective corners of the first handle assembly 210, and
wherein the second handle assembly 220 comprises a third angled face 225 and a fourth angled face 226 disposed at respective corners of the second handle assembly 220.
6. The filing tool of example 5, wherein the first angled face 215 is substantially parallel with the third angled face 225 and the second angled face 216 is substantially parallel with the fourth angled face 226.
7. The filing tool of example 6, wherein the first angled face 215 and the third angled face 225 are both substantially parallel to a direction of extension of the chain 100 responsive to the filing tool 200 being aligned in the first orientation to file the first cutter links 180.
8. The filing tool of example 7, wherein the first handle assembly 210 further comprises a first alignment indicator 212 configured to confirm proper alignment of the filing tool 200 relative to the chain 100 responsive to the filing tool 200 being aligned in the first orientation to file the first cutter links 180.
9. The filing tool of example 6, wherein the second angled face 216 and the fourth angled face 226 are both substantially parallel to a direction of extension of the chain 100 responsive to the filing tool 200 being aligned in the second orientation to file the second cutter links 180.
10. The filing tool of example 9, wherein the first handle assembly 210 further comprises a second alignment indicator 214 configured to confirm proper alignment of the filing tool 200 relative to the chain 100 responsive to the filing tool 200 being aligned in the second orientation to file the second cutter links 180.
11. The filing tool of example 1, wherein a cross section of the first and second cutter files 260, 270 is circular.
12. The filing tool of example 1, wherein a cross section of the first and second cutter files 260, 270 is hexagonal or goofy shaped.
13. The filing tool of example 1, wherein the depth gauge file 250 has a planar filing surface or an arcuate filing surface.
14. The filing tool of example 12, wherein the depth gauge file 250 has a trapezoidal cross section.
15. The filing tool of example 1, wherein at least one of the first and second handle assemblies 210, 220 comprises an opening assembly 280 configured to allow the depth gauge file 250, the first cutter file 260, and the second cutter file 270 to slide in a direction substantially parallel to the first and second guide rails 230, 240 in order for the first or second cutter files (260, 270) or the depth gauge file 250 to be replaced.
16. The filing tool of example 1, wherein at least one of the first and second handle assemblies 210, 220 comprises an opening assembly 280 configured to allow the depth gauge file 250, the first cutter file 260, and the second cutter file 270 to lift in a direction normal to the first and second guide rails 230, 240 in order for the first or second cutter files 260, 270 or the depth gauge file 250 to be replaced.
17. A filing tool 200 for sharpening a chain 100 for a chainsaw, the filing tool 200 comprising:
a first handle assembly 210 disposed at a first end of the filing tool 200;
a second handle assembly 220 disposed a fixed distance away from the first handle assembly 210 at a second end of the filing tool 200;
a first guide rail 230 operably coupling the first handle assembly 210 to the second handle assembly 220;
a second guide rail 240 operably coupling the first handle assembly 210 to the second handle assembly 220, the second guide rail 240 being substantially parallel to the first guide rail 230;
a depth gauge file 250 disposed between the first guide rail 230 and the second guide rail 240;
a first cutter file 260 disposed between the first guide rail 230 and the depth gauge file 250; and
a second cutter file 270 disposed between the second guide rail 240 and the depth gauge file 250,
wherein the depth gauge file 250 is disposed in a first plane 290 containing the first guide rail 230 and the second guide rail 240,
wherein the first cutter file 260 and the second cutter file 270 are coplanar in a second plane 300 disposed on a same side of the first plane 290.
18. The filing tool of example 17, wherein the depth gauge file 250 is movable out of the first plane 290 to file a depth gauge 170 of the chain 100 to a different level.
19. The filing tool of example 17, wherein the first handle assembly 210 comprises a first angled face 215 and a second angled face 216 disposed at respective corners of the first handle assembly 210, and wherein the second handle assembly 220 comprises a third angled face 225 and a fourth angled face 226 disposed at respective corners of the second handle assembly 220.
20. The filing tool of example 19, wherein the first angled face 215 is substantially parallel with the third angled face 225 and the second angled face 216 is substantially parallel with the fourth angled face 226.

1. A filing tool for simultaneously filing a cutting portion and a depth gauge portion of a saw chain for a chainsaw, the filing tool comprising:
a first handle assembly and a second handle assembly,
a first guide rail and a second guide rail, each having one end connected to the first handle assembly and the other end connected to the second handle assembly, the first and second guide rails being mutually parallel and defining a guide plane,
the first and second handle assemblies each comprising at least one holder configured to hold ends of a depth gauge file, such that the depth gauge file is retained therebetween, located between and being parallel with the first and a second guide rails,
the first and second handle assemblies each comprising least one holder configured to hold the ends of a first cutter file and a second cutter file retained therebetween, such that
the first cutter file extends, parallel with the first and second guide rails in between the first guide rail and the depth gauge file as seen in a normal direction from the guide plane,
the second cutter file extends, parallel with the first and second guide rails in between the second guide rail and the depth gauge file as seen in a normal direction from the guide plane, wherein the first and second cutter files are located on a same side of the guide plane.

2. The filing tool of claim 1, wherein the depth gauge file is movable towards and away from the guide plane.

3. The filing tool of claim 1, wherein the first handle assembly comprises a first angled face and a second angled face disposed at respective corners of the first handle that face the first and second guide rails.

4. The filing tool of claim 1, wherein the second handle assembly, comprises a third angled face and a fourth angled face disposed at respective corners of the second handle assembly that face the first and second guide rails.

5. The filing tool of claim 4, wherein at least one of said first, second, third or fourth angled faces form an angle of 10-35 degrees with respect to a direction of the guide rails.

6. The filing tool of claim 5, wherein the first angled face is substantially parallel with the third angled face and the second angled face is substantially parallel with the fourth angled face.

7. The filing tool of claim 6, wherein the first handle assembly further comprises a first alignment indicator configured to confirm proper alignment of the filing tool relative to the saw chain responsive to the filing tool being aligned in a first orientation to file a first cutter links.

8. The filing tool of claim 7, wherein the second angled face and the fourth angled face are both substantially parallel to a direction of extension of the saw chain responsive to the filing tool being aligned in a second orientation to file the second cutter links.

9. The filing tool of claim 8, wherein the first handle assembly further comprises a second alignment indicator configured to confirm proper alignment of the filing tool relative to the saw chain responsive to the filing tool being aligned in the second orientation to file a second cutter links.

10. (canceled)

11. The filing tool of claim 1, wherein a cross section of the first and second cutter files is circular.

12. The filing tool of claim 1, wherein a cross section of the first and second cutter files is hexagonal or goofy shaped.

13. The filing tool of claim 1, wherein the depth gauge file has a planar filing surface or an arcuate filing surface.

14. The filing tool of claim 1, wherein the depth gauge file has a trapezoidal cross section.
